(19) United States
(12) Patent Application Publication
(10) Pub. No.: US 2011/0159284 A1
(43) Pub. Date: Jun. 30, 2011

(54) ADHESIVE COMPOSITION FOR SEMICONDUCTOR DEVICE AND DIE ATTACH FILM

(76) Inventors: Jae Won CHOI, Uiwang-si (KR); Jin Man Kim, Uiwang-si (KR); Ki Tae Song, Uiwang-si (KR)

(21) Appl. No.: 12/970,004

(22) Filed: Dec. 16, 2010

(30) Foreign Application Priority Data
Dec. 30, 2009 (KR) 10-2009-0134709

(51) Int. Cl. C09J 163/00; C09J 163/02; C09J 163/04; B32B 27/38

(52) U.S. Cl. 428/355 EP; 523/427

(57) ABSTRACT

An adhesive composition for a semiconductor device and a die attach film for a semiconductor device, the adhesive composition including about 50 to about 80 parts by weight of an elastomeric resin; about 10 to about 20 parts by weight of an epoxy resin, the epoxy resin including a difunctional epoxy resin and polyfunctional epoxy resins and the difunctional epoxy resin being present in an amount of about 20 to about 60 parts by weight with respect to 100 parts by weight of the epoxy resin; about 1 to about 10 parts by weight of a curable resin; about 0.01 to about 10 parts by weight of a curing accelerator; about 0.01 to about 10 parts by weight of a silane coupling agent; and about 5 to about 10 parts by weight of a filler.

### 1. FIELD

Embodiments relate to an adhesive composition for a semiconductor device and a die attach film.

### 2. DESCRIPTION OF THE RELATED ART

To keep pace with the trend towards smaller and highly integrated semiconductor devices, die attach films (DAFs) for use in a dicing process to laminate semiconductor chips with each other or to attach semiconductor chips to substrates may be used. For semiconductor assembly, a die attach film may be used to support a wafer in a sawing process to cut the wafer into individual chips, in a pick-up process to pick up the chips, and in a dicing process to mount the chips. One of the picked-up chips may be mounted on a package substrate or another chip in a state in which an adhesive layer is adhered to a lower surface thereof. The adhesive layer may maintain coupling between the package substrate and the overlying chip or between the chips.

### SUMMARY

Embodiments are directed to an adhesive composition for a semiconductor device and a die attach film.

The embodiments may be realized by providing an adhesive composition for a semiconductor device, the adhesive composition including about 50 to about 80 parts by weight of an elastomeric resin; about 10 to about 20 parts by weight of an epoxy resin, the epoxy resin including a difunctional epoxy resin and polyfunctional epoxy resins and the difunctional epoxy resin being present in an amount of about 20 to about 60 parts by weight with respect to 100 parts by weight of the epoxy resin; about 1 to about 10 parts by weight of a curable resin; about 0.01 to about 10 parts by weight of a curing accelerator; about 0.01 to about 10 parts by weight of a silane coupling agent; and about 5 to about 10 parts by weight of a filler.

The epoxy resin may include a mixture of the polyfunctional epoxy resins and the difunctional epoxy resin in a weight ratio (w/w) of about 1:1.1 to about 1:0.2.

The epoxy resin may include a mixture of the polyfunctional epoxy resins and the difunctional epoxy resin in a weight ratio (w/w) of about 3.09:0.78 to about 2.23:1.46.

The difunctional epoxy resin may include one of a bisphenol F, bisphenol A, or bisphenol AD epoxy resin.

The polyfunctional epoxy resins may include a mixture of a cresol novolac type epoxy resin and a phenol novolac type epoxy resin in a weight ratio (w/w) of about 1:0.8 to about 1:1.7.

The polyfunctional epoxy resins may include a mixture of a cresol novolac type epoxy resin and a phenol novolac type epoxy in a weight ratio (w/w) of about 1.92:1.03 to about 1.51:1.58.

An adhesive prepared from the adhesive composition may have a shear viscosity of about 1.50×10⁶ poise to about 2.30×10⁶ poise at 170° C. after semi-curing at 125° C.

An adhesive prepared from the adhesive composition may have a shear viscosity of about 1.79×10⁶ poise to about 2.26×10⁶ poise at 170° C. after semi-curing at 125° C.

The embodiments may also be realized by providing a die attach film for a semiconductor device, the die attach film including an adhesive layer prepared from the adhesive composition of an embodiment; and a base layer supporting the adhesive layer.

The embodiments may also be realized by providing a die attach film for a semiconductor device, the die attach film including an adhesive prepared from an adhesive composition, wherein the adhesive composition includes about 50 to about 80 parts by weight of an elastomeric resin; about 10 to about 20 parts by weight of an epoxy resin, the epoxy resin including a difunctional epoxy resin and polyfunctional epoxy resins and the difunctional epoxy resin being present in an amount of about 20 to about 60 parts by weight with respect to 100 parts by weight of the epoxy resin; about 1 to about 10 parts by weight of a curable resin; about 0.01 to about 10 parts by weight of a curing accelerator; about 0.01 to about 10 parts by weight of a silane coupling agent; and about 5 to about 10 parts by weight of a filler, and the adhesive has a shear viscosity of about 1.5×10⁶ poise to about 2.30×10⁶ poise at 170° C. after curing at 125° C.

The adhesive may have a shear viscosity of about 1.79×10⁶ poise to about 2.26×10⁶ poise at 170° C. after semi-curing at 125° C.

The embodiments may also be realized by providing a die attach film for a semiconductor device, attaching semiconductor chips to each other, or attaching a semiconductor chip to a substrate, the die attach film including an elastomeric resin; a difunctional epoxy resin; polyfunctional epoxy resins; and a filler, wherein the die attach film has a shear viscosity of about 1.5×10⁶ poise to about 2.30×10⁶ poise at 170° C. after curing at 125° C.

The die attach film may further include about 1 to about 10 parts by weight of a curable resin; about 0.01 to about 10 parts by weight of a curing accelerator; and about 0.01 to about 10 parts by weight of a silane coupling agent, wherein the die attach film includes about 50 to about 80 parts by weight of the elastomeric resin and about 10 to about 20 parts by weight of an epoxy resin including the difunctional epoxy resin and the polyfunctional epoxy resins, the difunctional epoxy resin being present in an amount of about 20 to about 60 parts by weight with respect to 100 parts by weight of the epoxy resin.

### BRIEF DESCRIPTION OF THE DRAWINGS

The embodiments will become more apparent to those of ordinary skill in the art by describing in detail exemplary embodiments with reference to the attached drawings, in which:

FIG. 1 illustrates a sectional view of a die attach film for a semiconductor device according to an embodiment; and

FIGS. 2 and 3 illustrate sectional views of chip packages, each of which including adhesive layers formed of an adhesive composition for a semiconductor device according to an embodiment.

### DETAILED DESCRIPTION

Korean Patent Application No. 10-2009-0134709, filed on Dec. 30, 2009, in the Korean Intellectual Property Office, and entitled: “Adhesive Composition for Semiconductor Device and Die Attach Film Comprising the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The embodiments provide an adhesive composition for a semiconductor device that provides an adhesive capable of effectively removing voids, which may be formed in a die attach process, during molding with an epoxy molding compound (EMC). Effective removal of voids by the adhesive may raise the reliability of a semiconductor package. The embodiments also provide a die attach film formed from the adhesive composition.

Embodiments provide an adhesive composition for a semiconductor device, which may be used to prepare a die attach film (DAF), and a die attach film formed from the adhesive composition. The adhesive composition may include a difunctional epoxy resin and polyfunctional epoxy resins as resin components of an epoxy resin to maintain a relatively low shear viscosity of an adhesive prepared therefrom, even after curing prior to EMC molding. The difunctional epoxy resin may be present in an amount of about 30 to about 50 parts by weight, based on 100 parts by weight of the epoxy resin.

The adhesive composition may provide an adhesive having a shear viscosity of about 1.5×10⁶ poise to about 2.30×10⁶ poise, as measured using an ARES rheometer at 170° C. after semi-curing twice in an oven at 125° C. for 60 min. Maintaining the shear viscosity at about 2.30×10⁶ poise or less may help ensure the ability of the adhesive to remove voids. Maintaining the shear viscosity at about 1.5×10⁶ poise or greater may help prevent a drastic reduction in die shear strength of the adhesive after reflow. An adhesive layer formed from the adhesive composition may promote effective removal of voids during subsequent EMC molding at 170° C. to prevent the voids from remaining after the EMC molding. Further, interfacial voids generated during die attach may escape outside or may be dissipated in the adhesive layer by pressure applied during the EMC molding.

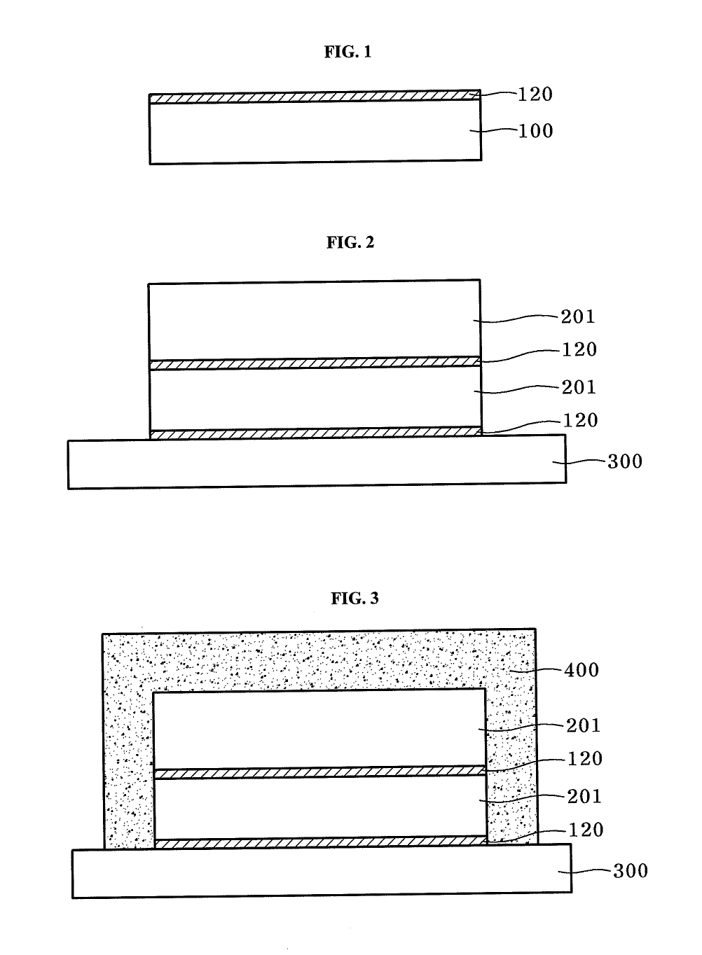

FIG. 1 illustrates a die attach film for a semiconductor device according to an embodiment.

Referring to FIG. 1, an adhesive layer 120 may be formed on a base film 100. The adhesive layer 120 may be formed from the adhesive composition of an embodiment. The adhesive composition may include an epoxy resin including a difunctional epoxy resin and polyfunctional epoxy resins. The base film 100 may include, e.g., a polyvinyl film, polyolefin film, or polyethylene terephthalate (PET) film. In an implementation, a PET film as a cover film may be adhered to the adhesive layer 120.

Individual components of the adhesive composition will be explained below.

Organic Solvent

The organic solvent may lower a viscosity of the adhesive composition to facilitate mixing of the components for film formation. An amount of the organic solvent remaining in the adhesive film may be limited to less than about 2%. Maintaining the amount of the organic solvent remaining in the adhesive film at less than about 2% may help prevent the solvent from adversely affecting physical properties of the adhesive film.

The organic solvent may include, e.g., benzene, acetone, methyl ethyl ketone, tetrahydrofuran, dimethylformaldehyde, cyclohexane, propylene glycol monomethyl ether acetate, and/or cyclohexanone. The organic solvent may render the adhesive composition homogeneous to provide the adhesive capable of reducing the number of voids, which may be subsequently formed during processing. Further, small amounts of residual organic solvent may function to soften the film.

Elastomeric Resin

The elastomeric resin may include, e.g., an acrylic polymer resin. The elastomeric resin may include, e.g., a rubber component containing hydroxyl, carboxyl, or epoxy groups. A glass transition temperature and molecular weight of the acrylic polymer resin may be easily controlled by selection of suitable monomers for polymerization. For example, introduction of functional groups to side chains of the acrylic polymer resin may be advantageous. Suitable monomers for the preparation of the acrylic polymer resin by copolymerization may include, e.g., acrylonitrile, butyl acrylate, butyl methacrylate, 2-ethylhexyl acrylate, acrylic acid, 2-hydroxyethyl (meth)acrylate, methyl (meth)acrylate, styrene monomers, glycidyl (meth)acrylate, isooctyl acrylate, and/or stearyl methacrylate.

Acrylic polymer resins may be classified based on, e.g., epoxy equivalent weight, glass transition temperature, and molecular weight. For example, a SG-P3 series product (Nagase Chemtex) having an epoxy equivalent weight not higher than about 10,000 may be used as the acrylic polymer resin. The acrylic polymer resin may be present in an amount of about 50 to about 80 parts by weight, based on 100 parts by weight of the adhesive composition. Maintaining the amount of the acrylic polymer resin at about 50 parts by weight or greater may help facilitate formation of a film. Maintaining the amount of the acrylic polymer resin at about 80 parts by weight or less may help prevent a deterioration in reliability.

Epoxy Resin

The epoxy resin may have a high cross-linking density, e.g., sufficient to exhibit strong curing and adhesive functions. Curing density of the epoxy resin may be controlled by mixing a difunctional epoxy resin with polyfunctional epoxy resins to ensure that an adhesive prepared from the adhesive composition has a low shear viscosity even after curing. The difunctional epoxy resin may be present in an amount of about 20 to about 60 parts by weight, based on 100 parts by weight of the epoxy resin.

The difunctional epoxy resin may include, e.g., bisphenol F, bisphenol A, and/or bisphenol AD epoxy resins. For example, a bisphenol F epoxy resin, such as YSLV-80XY commercially available from Kukdo Chemical Co., Ltd., may be used as the difunctional epoxy resin. The difunctional epoxy resin may be included in the adhesive composition to maintain a low viscosity of the adhesive prepared from the adhesive composition even after semi-curing. Other examples of the difunctional epoxy resin may include: Epicoat 807, Epicoat 827 and Epicoat 828, which are commercially available from Yuka Shell Epoxy Co., Ltd.; D.E.R 330, D.E.R. 331 and D.E.R. 361, which are commercially available from Dow Chemical; and YD128 and YDF 170, which are commercially available from Tohto Kasei Co., Ltd.

Including a mixture of the polyfunctional epoxy resins in the adhesive composition may facilitate more stable curing of the adhesive prepared from the adhesive composition. Examples of the polyfunctional epoxy resins may include ortho-cresol novolac type epoxy resins, such as YDCN-500-90P available from Kukdo Chemical Co., Ltd., and phenol novolac type epoxy resins, such as EPPN-501H available from Nippon Kayaku Co., Ltd.

The polyfunctional epoxy resins may be present in an amount of at least about 40 parts by weight, based on 100 parts by weight of the epoxy resin. Maintaining the amount of the polyfunctional epoxy resins at about 40 parts by weight or greater may help ensure sufficient cross-linking density of the adhesive composition. Sufficient cross-linking density may help maintain internal bonding strength of a final structure, thereby ensuring reliability. The polyfunctional epoxy resins may be mixed with the difunctional epoxy resin in a ratio of about 1:1.1 to about 1:0.2. It may be more effective to mix the polyfunctional epoxy resins with the difunctional epoxy resin in a ratio of about 3.09:0.78 to about 2.23:1.46. Each of the polyfunctional epoxy resins may include a mixture of a cresol novolac type epoxy resin and a phenol novolac type epoxy resin. In an implementation, a mixing ratio of the cresol novolac type epoxy resin to the phenol novolac type epoxy may be about 1:0.8 to about 1:1.7, e.g., about 1.92:1.03 to about 1.51:1.58.

The epoxy resin may be present in an amount of about 5 to about 50 parts by weight, e.g., about 10 to about 20 parts by weight, based on 100 parts by weight of the adhesive composition. Maintaining the amount of the epoxy resin at about 5 parts by weight or greater may help ensure complete curing, thereby ensuring good reliability. Maintaining the amount of the epoxy resin at about 50 parts by weight or less may help prevent a deterioration in compatibility of the film.

The epoxy resin may have an epoxy equivalent weight of about 100 to about 1,500 g/eq. Maintaining the epoxy equivalent weight of the epoxy resin at about 100 g/eq. or greater may help ensure good adhesiveness of the film after curing. Maintaining the epoxy equivalent weight of the epoxy resin at about 1,500 g/eq. or less may help ensure that the adhesive prepared from the adhesive composition exhibits good heat resistance and may help prevent a reduction in glass transition temperature. In an implementation, the epoxy resin may have an epoxy equivalent weight of about 150 to about 800 g/eq. In another implementation, the epoxy resin may have an epoxy equivalent weight of about 150 to about 400 g/eq.

Curable Phenolic Resin

The curable phenolic resin may have two or more phenolic hydroxyl groups in one molecule. Suitable curable phenolic resins may include, e.g., bisphenol A, bisphenol F, and bisphenol S resins, phenol novolac resins, bisphenol A novolac resins, cresol novolac resins, xyloc resins, and biphenyl resins, all of which may be highly resistant to electrolytic corrosion upon moisture absorption. The curable phenolic resin may have a simple phenolic structure, e.g., HF-1M available from Meiwa Kasei Co., Ltd.

The curable phenolic resin may have a hydroxyl equivalent weight of about 100 to about 600 g/eq. Maintaining the hydroxyl equivalent weight of the curable phenolic resin at about 100 g/eq. or greater may help prevent high moisture absorption and may help ensure good reflow resistance. Maintaining the hydroxyl equivalent weight of the curable phenolic resin at about 600 g/eq. or less may help ensure that the low glass transition temperature is not too low and may help ensure good heat resistance. In an implementation, the curable phenolic resin may have a hydroxyl equivalent weight of about 170 to about 300 g/eq.

The curable phenolic resin may be present in an amount of about 1 to about 10 parts by weight, based on 100 parts by weight of the adhesive composition. In an implementation, the curable phenolic resin may be present in an amount of about 3 to about 6 parts by weight, based on 100 parts by weight of the adhesive composition.

The curable phenolic resin may be used in combination with a curable amino resin. For example, the curable amino resin may include DDS available from Wako Chemical Co. Ltd. The curable amino resin may be present in an amount of about 1 to about 10 parts by weight, e.g., about 1 to about 3 parts by weight, based on 100 parts by weight of the adhesive composition. The curable phenolic resin and the curable amino resin may be included in a ratio of about 1:0.2 to about 1:0.6.

Curing Accelerator

The curing accelerator may be added to control a curing rate of the adhesive composition. Suitable curing accelerators may include phosphine-, boron-, and imidazole-based curing accelerators. For example, the curing accelerator may include TPP-K available from Hokko Chemical Industry Co., Ltd. The curing accelerator may be present in an amount of about 0.01 to about 10 parts by weight, e.g., about 0.12 to about 0.3 parts by weight, based on 100 parts by weight of the adhesive composition.

Silane Coupling Agent

The silane coupling agent may be added to enhance adhesion between a surface of an inorganic material (e.g., silica) and resin components of the die attach film. The silane coupling agent may include any suitable silane coupling agent commonly used in the art. The silane coupling agent may include, e.g., KBM-303 commercially available from Shin-Etsu Chemical Co., Ltd. The silane coupling agent may be present in an amount of about 0.01 to about 10% by weight, based on 100% by weight of the adhesive composition. In an implementation, the silane coupling agent may be present in an amount of about 1 to about 3 wt %, based on 100% by weight of the adhesive composition.

Filler

The filler may be added to control melt viscosity of the adhesive composition. The filler may include an inorganic or organic filler. Examples of suitable inorganic fillers for the adhesive composition may include metallic components, such as gold, silver, copper, and nickel powders; and non-metallic components, such as alumina, aluminum hydroxide, magnesium hydroxide, calcium carbonate, magnesium carbonate, calcium silicate, magnesium silicate, calcium oxide, magnesium oxide, aluminum oxide, aluminum nitride, silica, boron nitride, titanium dioxide, glass, iron oxide, and ceramic. Examples of suitable organic fillers may include carbon, rubber fillers, and polymer fillers. There is no particular restriction on the shape and size of the filler. For example, the filler may include spherical silica. In an implementation, the filler may have a particle diameter of about 500 nm to about 5 μm. For example, the adhesive composition may include commercially available R-972 from Degussa as the filler. The filler may be used in an amount of about 1 to about 40 parts by weight, e.g., about 5 to about 10 parts by weight, based on 100 parts by weight of the adhesive composition.

The adhesive composition may be prepared by dissolving the elastomeric resin, the epoxy resin, the curable phenolic resin, the curing accelerator, the silane coupling agent, and the filler in the organic solvent, e.g., methyl ethyl ketone or cyclohexanone. In an implementation, the adhesive composition may be prepared by dissolving the elastomeric resin, the epoxy resin, the curable phenolic resin, the curable amino resin, the curing accelerator, the silane coupling agent, and the filler in the organic solvent, e.g., methyl ethyl ketone or cyclohexanone. The adhesive composition may be kneaded using a bead mill, applied to a release-treated PET film using an applicator, and dried in an oven at about 80 to about 120° C., e.g., at 100° C., for about 10 to about 30 min to form an adhesive layer, completing the production of the die attach film illustrated in FIG. 1. The adhesive layer (denoted by numeral 120 in FIG. 1) may be formed to a thickness of about 5 μm to about 200 μm, e.g., about 5 to about 100 μm. Maintaining the thickness of the adhesive layer at about 5 μm or greater may help ensure that a sufficient adhesive strength is obtained. Maintaining the thickness of the adhesive layer at about 200 μm or less may be economically advantageous.

FIGS. 2 and 3 illustrate semiconductor packages to which the die attach film according to an embodiment is applied.

Referring to FIGS. 1-3, a wafer (not illustrated) may be mounted in contact with the adhesive layer 120 on the base layer 100 and may be diced into individual chips 201 by, e.g., sawing. One of the chips 201 may be picked up and mounted on a package substrate 300 such that the adhesive layer 120 is directly attached to the package substrate 300. Another chip 201 may be mounted on the chip 201 to fabricate a multilayer chip package, e.g., a quad die package (QDP) or a dual die package (DDP). Then, the chip package including the chips 201 mounted therein may be semi-cured at about 125° C. for about 60 min. This semi-curing is a process for half curing the adhesive layer(s) 120. If desired, the semi-curing may be repeated about two to about six times.

The chip attach and/or curing may leave voids resulting from non-uniform gaps at an interface between the underlying adhesive layer 120 and the package substrate 300 or at an interface between the adhesive layers 120 and the chips 201. Voids may be formed because of, e.g., rough surfaces of the package substrate, the adhesive layers, and the chips.

Referring to FIG. 3, a molding layer 400 may be formed by molding the chip package with an epoxy molding compound (EMC). For example, the EMC may be SG-8500B available from Cheil Industries Inc. The molding may be conducted at about 175° C. for about 60 sec. Without being bound by theory, it is believed that due to a relatively low shear viscosity of the adhesive layers 120, the voids may escape outside from the interface between the underlying adhesive layer 120 and the package substrate 300 and the other interfaces or may be dissipated in the adhesive layers 120 during molding. For example, the relatively low shear viscosity of the adhesive layers 120 may facilitate removal of the voids from the chip package. For example, maintaining a relatively low viscosity of the adhesive layers 120 may facilitate migration or dissipation of voids, thereby ensuring that the voids do not remain after molding. In the present embodiment, the shear viscosity of the adhesive layer 120 may be maintained low after curing, thereby facilitating the removal of voids. Thus, defects, e.g., cracks or fractures, resulting from voids may be effectively inhibited.

Hereinafter, the embodiments are illustrated in more detail with reference to examples. However, they are exemplary embodiments and are not limiting. The following examples are provided to assist in a further understanding of the invention and are in no way intended to limit the scope of the invention. Embodiments that are not included herein will be readily recognized and appreciated by those skilled in the art, and thus their explanation is omitted. The following examples and experiments are given for illustrative purposes only and are not intended to limit the scope of this disclosure.

### EXAMPLES

### Examples 1-3 and Comparative Example 1

### Preparation of Adhesive Compositions

As shown in Table 1, the components were dissolved in cyclohexanone as an organic solvent to prepare adhesive compositions.

TABLE 1

| | | | | Com- |
|---|---|---|---|---|
| | | | | parative |
| | Example 1 | Example 2 | Example 3 | Example 1 |
| | weight % | weight % | weight % | weight % |
| Elastomeric resin⁽¹⁾ | 69.00 | 69.00 | 69.00 | 69.00 |
| Epoxy resin⁽²⁾ | 4.10 | 5.20 | 3.90 | 7.56 |
| Epoxy resin⁽³⁾ | 3.90 | 5.00 | 7.30 | — |
| Epoxy resin⁽⁴⁾ | 6.40 | 4.20 | 3.20 | 4.20 |
| Curable phenolic resin⁽⁵⁾ | 4.00 | 4.00 | 4.00 | 5.40 |
| Curable amino resin⁽⁶⁾ | 2.30 | 2.30 | 2.30 | 1.20 |
| Silane coupling agent⁽⁷⁾ | 2.00 | 2.00 | 2.00 | 2.00 |
| Curing accelerator⁽⁸⁾ | 0.30 | 0.30 | 0.30 | 0.30 |
| Filler⁽⁹⁾ | 8.00 | 8.00 | 8.00 | 10.00 |
| Total amount (weight | 100.00 | 100.00 | 100.00 | 99.66 |
| parts in solid state) | | | | |

Note:
⁽¹⁾Elastomeric resin: SG-P3, Nagase Chemtex
⁽²⁾Epoxy resin: YDCN-500-90P, Kukdo Chemical
⁽³⁾Epoxy resin: YSLV-80XY, Kukdo Chemical
⁽⁴⁾Epoxy resin: EPPN-501H, Nippon Kayaku
⁽⁵⁾Curable phenolic resin: HF-1M, Meiwa Kasei
⁽⁶⁾Curable amino resin: DDS, Wako chemical
⁽⁷⁾Silane coupling agent: KBM-403, Shinetsu
⁽⁸⁾Curing accelerator: TPP-K, HOKKO
⁽⁹⁾Filler: R-972, Degussa
*Cyclohexanone was used as an organic solvent

Formation of adhesive layers

Each of the compositions was kneaded using a bead mill, applied to a release-treated polyethylene terephthalate (PET) film as a base layer using an applicator, and dried in an oven at 100° C. for 30 min to form a 100 μm thick adhesive layer, completing the production of a die attach film for semiconductor assembly.

Physical properties of the die attach films were evaluated, and the results are shown in Table 2.

TABLE 2

| | | | | | | Comparative |
|---|---|---|---|---|---|---|
| Physical properties | Semi-curing | Unit | Example 1 | Example 2 | Example 3 | Example 1 |
| Amount of heat | 0 cycle | J/g | 26 | 27 | 20 | 18 |
| emitted during curing | | | | | | |
| Curing residual ratio | 2 cycles | % | 60 | 58 | 50 | 50 |
| Removal of voids by | Criterion: 10% | | Removed | Removed | Removed | Unremoved |
| molding | | | | | | |
| Die shear strength | | Kgf/chip | 11.9 | 13.7 | 12.5 | 16.8 |
| after reflow | | | | | | |
| Shear viscosity before | 2 cycles, | 10⁶ poise | 2.14 | 2.26 | 1.79 | 2.84 |
| molding | measured | | | | | |
| | at 170° C. | | | | | |

Note:
Semi-curing in an oven at 125° C. for 60 min was defined as one cycle.

Evaluation of physical properties of the die attach films

Physical properties of the die attach films produced in Examples 1-3 and Comparative Example 1 were evaluated by the following procedures.

(1) The amount of heat emitted during curing of each of the adhesive compositions was measured using a differential scanning calorimeter (DSC) (heating rate=10° C./min, scanning range=0˜300° C.).

(2) Curing residual ratio: Each of the adhesive compositions was semi-cured in an oven at 125° C. for 60 min, which was defined as one cycle. After two cycles of semi-curing was performed, the amount of heat emission was measured. The curing residual ratio was calculated by dividing the amount of heat emission after two cycles of the semi-curing by the amount of heat emitted during the initial curing.

(3) Removal of voids by molding: Each of the films was mounted on a 100 μm thick wafer coated with a silicon oxide (SiO₂) film and cut into pieces having sizes of 8 mm×8 mm and 10 mm×10 mm. The pieces were attached to a QDP package to form a bilayer structure, followed by two cycles of semi-curing. The cured chip package was molded with an EMC (SG-8500B, Cheil Industries Inc.) at 175° C. for 60 seconds. A scanning acoustic tomography (SAT) was used to determine whether voids were present in the chip package. It was judged to be “removed” when the area occupied by voids were not larger than 10% and “unremoved” when the area occupied by voids were exceeded 10%.

(4) Die shear strength after reflow: A 530 μm thick wafer coated with a dioxide film was cut into chips having a size of 5 mm×5 mm. The chips were laminated with each of the die attach films at 60° C. The laminate was cut to leave an attached portion only. The overlying chip was positioned on an Alloy 42 lead frame (10 mm×10 mm). The resulting structure was pressurized under a load of 1 kgf on a hot plate at 120° C. for 1 sec to attach the chip to the lead frame, and was then cured at 170-175° C. for 2 hr. The test piece was allowed to absorb moisture at 85° C. and 85 RH % for 168 hr, and reflowing was performed three times at a maximum temperature of 260° C. The die shear of the test piece was measured at 250° C.

(5) Shear viscosity before molding: Each of the adhesive compositions was semi-cured in an oven at 125° C. for 60 min, which was defined as one cycle. After two cycles of semi-curing, the shear viscosity of the adhesive composition was measured at 170° C. using an ARES rheometer. At this time, a pressure of 1 kgf was applied taking into consideration the pressure of a mold.

As can be seen from the results in Table 2, the adhesive compositions of Examples 1-3 exhibited high curing residual ratios (≧50%) and it was determined that voids were “removed”. In contrast, in the adhesive composition of Comparative Example 1 it was determined that voids were “unremoved.” Further, the adhesive compositions of Examples 1-3 had much lower shear viscosities than the adhesive composition of Comparative Example 1 and could maintain their low shear viscosities during molding. These results reveal that voids effectively dissipated in the adhesive layers of Examples 1-3.

The embodiments provide a die attach film for a semiconductor device to effectively remove voids, which may be formed during die attach and/or curing, in the course of subsequent EMC molding, thus achieving high reliability in package processing. Voids arising during processing should be removed by EMC molding. However, voids may be sufficiently removed from an adhesive having high modulus. Thus, the use of the difunctional epoxy resin in the adhesive composition of an embodiment may maintain a low shear viscosity of the film even after die attach and two cycles of semi-curing.

The low viscosity of the adhesive layer may facilitate smooth migration of voids during EMC molding to induce effective removal of the voids. Further, the addition of the difunctional epoxy resin for curing density control may maintain a lower shear viscosity of the adhesive layer during die attach and semi-curing, thereby achieving relatively high interfacial adhesive strength. Therefore, the adhesive composition may provide an adhesive that imparts higher adhesive strength to the interfaces between a semiconductor chip and a package substrate or the interfaces between semiconductor chips to suppress the formation of voids and prevent voids from remaining in a package, thus raising the reliability of the package.

By way of summation and review, when a semiconductor wafer is attached to the adhesive layer of the die attach film, gaps may be created between a surface of the wafer or the semiconductor chips and the adhesive layer, resulting in formation of voids. Further, voids may also be formed in a semi-curing process to half-cure the adhesive layer after die attachment. Once the voids are formed, they should be removed during subsequent molding with an epoxy molding compound (EMC). Voids remaining in a package molded with the EMC may contribute to the formation of cracks in the package, resulting in defects in the package. Increasing an amount of a curable component in the adhesive layer may suppress the formation of voids. However, this approach may result in a lower tensile strength of the die attach film, causing cutting of the film in the dicing process or failure of the pick-up process. The embodiments provide an adhesive composition that provides an adhesive capable of reducing the formation of voids without reducing tensile strength of a die attach film, thereby preventing cutting of the film in the dicing process or failure of the pick-up process.

The embodiments provide an adhesive composition for a semiconductor device that can suppress formation of voids.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An adhesive composition for a semiconductor device, the adhesive composition comprising:
about 50 to about 80 parts by weight of an elastomeric resin;
about 10 to about 20 parts by weight of an epoxy resin, the epoxy resin including a difunctional epoxy resin and polyfunctional epoxy resins and the difunctional epoxy resin being present in an amount of about 20 to about 60 parts by weight with respect to 100 parts by weight of the epoxy resin;
about 1 to about 10 parts by weight of a curable resin;
about 0.01 to about 10 parts by weight of a curing accelerator;
about 0.01 to about 10 parts by weight of a silane coupling agent; and
about 5 to about 10 parts by weight of a filler.

2. The adhesive composition as claimed in claim 1, wherein the epoxy resin includes a mixture of the polyfunctional epoxy resins and the difunctional epoxy resin in a weight ratio (w/w) of about 1:1.1 to about 1:0.2.

3. The adhesive composition as claimed in claim 1, wherein the epoxy resin includes a mixture of the polyfunctional epoxy resins and the difunctional epoxy resin in a weight ratio (w/w) of about 3.09:0.78 to about 2.23:1.46.

4. The adhesive composition as claimed in claim 1, wherein the difunctional epoxy resin includes one of a bisphenol F, bisphenol A, or bisphenol AD epoxy resin.

5. The adhesive composition as claimed in claim 1, wherein the polyfunctional epoxy resins include a mixture of a cresol novolac type epoxy resin and a phenol novolac type epoxy resin in a weight ratio (w/w) of about 1:0.8 to about 1:1.7.

6. The adhesive composition as claimed in claim 1, wherein the polyfunctional epoxy resins include a mixture of a cresol novolac type epoxy resin and a phenol novolac type epoxy in a weight ratio (w/w) of about 1.92:1.03 to about 1.51:1.58.

7. The adhesive composition as claimed in claim 1, wherein an adhesive prepared from the adhesive composition has a shear viscosity of about 1.50×10⁶ poise to about 2.30×10⁶ poise at 170° C. after semi-curing at 125° C.

8. The adhesive composition as claimed in claim 1, wherein an adhesive prepared from the adhesive composition has a shear viscosity of about 1.79×10⁶ poise to about 2.26×10⁶ poise at 170° C. after semi-curing at 125° C.

9. A die attach film for a semiconductor device, the die attach film comprising:
an adhesive layer prepared from the adhesive composition as claimed in claim 1; and
a base layer supporting the adhesive layer.

10. A die attach film for a semiconductor device, the die attach film comprising an adhesive prepared from an adhesive composition, wherein:
the adhesive composition includes:
about 50 to about 80 parts by weight of an elastomeric resin;
about 10 to about 20 parts by weight of an epoxy resin, the epoxy resin including a difunctional epoxy resin and polyfunctional epoxy resins and the difunctional epoxy resin being present in an amount of about 20 to about 60 parts by weight with respect to 100 parts by weight of the epoxy resin;
about 1 to about 10 parts by weight of a curable resin;
about 0.01 to about 10 parts by weight of a curing accelerator;
about 0.01 to about 10 parts by weight of a silane coupling agent; and
about 5 to about 10 parts by weight of a filler, and
the adhesive has a shear viscosity of about 1.5×10⁶ poise to about 2.30×10⁶ poise at 170° C. after curing at 125° C.

11. The die attach film as claimed in claim 10, wherein the adhesive has a shear viscosity of about 1.79×10⁶ poise to about 2.26×10⁶ poise at 170° C. after semi-curing at 125° C.

12. A die attach film for a semiconductor device, attaching semiconductor chips to each other, or attaching a semiconductor chip to a substrate, the die attach film comprising:
an elastomeric resin;
a difunctional epoxy resin;
polyfunctional epoxy resins; and
a filler,
wherein the die attach film has a shear viscosity of about 1.5×10⁶ poise to about 2.30×10⁶ poise at 170° C. after curing at 125° C.

13. The die attach film as claimed in claim 12, further comprising:
about 1 to about 10 parts by weight of a curable resin;
about 0.01 to about 10 parts by weight of a curing accelerator; and
about 0.01 to about 10 parts by weight of a silane coupling agent,
wherein the die attach film includes about 50 to about 80 parts by weight of the elastomeric resin and about 10 to about 20 parts by weight of an epoxy resin including the difunctional epoxy resin and the polyfunctional epoxy resins, the difunctional epoxy resin being present in an amount of about 20 to about 60 parts by weight with respect to 100 parts by weight of the epoxy resin.
